(19) United States
(12) Patent Application Publication
(10) Pub. No.: US 2026/0311338 A1
(43) Pub. Date: Oct. 8, 2026

(54) DETECTING A CROPPED IMAGE BASED ON AN OBJECT SEGMENTATION MASK

(71) Applicant: Capital One Services, LLC, McLean, VA (US)

(72) Inventors: Deepak RAMAMOHAN, Mysuru (IN); Shah Aakash ATULBHAI, Ahmedabad (IN)

(73) Assignee: Capital One Services, LLC, McLean, VA (US)

(21) Appl. No.: 19/173,230

(22) Filed: Apr. 8, 2025

(51) Int. Cl. G06T 7/12; G06T 3/40; G06T 3/60; G06T 5/30; G06T 7/70; G06V 10/25

(52) U.S. Cl. CPC G06T 7/12; G06T 3/40; G06T 3/60; G06T 5/30; G06T 7/70; G06V 10/25

(57) ABSTRACT

Disclosed herein are system, method, and computer program product embodiments for improving image processing by detecting whether an object depicted in the image is cropped. A system generates a standardized mask from an image segmentation mask depicting an object within an image. The system modifies the image by adding a predefined number of pixels between an edge of the image and the standardized mask. The system then generates a mask edge based on the standardized mask and an eroded version of the standardized mask. The system determines the image is cropped by generating a first vector of the sum of each pixel value of each row in the image, generating a second vector of the sum of each pixel value of each column in the image, and identifying a summation in the first or second vector greater than a predefined threshold.

### BACKGROUND

### Field

This field is generally related to improving image processing through cropped object detection.

### Related Art

Digital platforms such as social media websites or e-commerce websites often host images from different sources. For example, an e-commerce website may allow different merchants to upload product information and execute transactions on the e-commerce website. Similarly, unrelated users may post content such as text, images, and video on a social media site. While the host platform displays the uploaded content (e.g., text, images, video), the host platform often has little control over the specification of the uploaded content. For example, the host platform may have little control over the size of the files (e.g., photos, videos) that are uploaded. As a result, unnecessarily large or corrupt files may be uploaded by users. These files may degrade network and operational performance at the host platform because of the computing resources needed to manipulate or process such files. Similarly, by hosting content from different sources, the host platform may appear visually disorganized.

### BRIEF SUMMARY

Disclosed herein are system, apparatus, device, method and/or computer program product embodiments, and/or combinations and sub-combinations thereof, for improving image processing by detecting whether an object depicted in the image is cropped. This disclosure describes a system that generates a standardized mask from an image segmentation mask depicting an object within the image. The system then modifies the image by adding a predefined number of pixels between an edge of the image and the standardized mask. Next, the system generates a mask edge by: (1) generating an eroded version of the standardized mask using an erosion kernel; and (2) removing the eroded version of the standardized mask from the standardized mask. The system then determines the image is cropped by: (1) generating a first vector storing the summation of each pixel of each row in the image; (2) generating a second vector by storing the summation of each pixel of each column in the image; and (3) identifying a summation within the first or second vector greater than a predefined threshold. By detecting that the image depicts a cropped object: (1) the image may be discarded or transmitted for further processing, thus reducing the amount of computing and networking resources expended to host the image; and (2) images from disparate sources appear more uniform.

### BRIEF DESCRIPTION OF THE DRAWINGS

The accompanying drawings are incorporated herein and form a part of the specification.

FIG. 1 depicts a block diagram of an environment, according to some embodiments.

FIG. 2 depicts an image segmentation mask of a cropped image, according to some embodiments.

FIGS. 3A & 3B depict generating a standardized image segmentation mask, according to some embodiments.

FIG. 4 depicts generating a mask edge, according to some embodiments.

FIGS. 5A – 5B depict plotting pixel value summations, according to some embodiments.

FIG. 6 depicts rotating an image to determine whether it depicts a cropped object, according to some embodiments

FIG. 7 depicts a flowchart illustrating a method for determining whether an image depicts a cropped object, according to some embodiments.

FIG. 8 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for improving image processing by detecting whether an image depicts an object that is cropped.

Internet platforms such as social media websites or e-commerce websites may host content from third parties. For example, users of the social media website may upload content including text, photos, videos, or any combination thereof, to the platform. Similarly, an e-commerce website may allow merchants to upload content including information related to products or services for sale. By hosting third party content, the platform has to accommodate the format (e.g., PNG file, JPEG file) and size (e.g., 1920x1080 resolution, 3840x2160 resolution) of the content. However, based on the computing resources at the host platform servers and the size of the uploaded content, performance at the host platform may be degraded. Similarly, hosting content from third parties may result in the website of the host platform appearing disjointed. Manually editing these images to impose uniformity is time consuming. Furthermore, using automated systems to edit the images may introduce undesired artifacts or unrecognizably alter the image. For example, an automated system may crop all images above a certain size. However, automatically cropping the image may distort or disfigure an object depicted in the image. This may be detrimental to an e-commerce website where the focus of the content is the image of the product for sale. As a result, the hosting platform: (1) wastes computing resources hosting a distorted image; and (2) the images on the host platform appear disjointed.

To address such technical challenges when processing electronic images, systems and methods are disclosed that determine whether an image depicts a cropped object, e.g., not entirely visible. For example, the system may receive an image of an object. In some embodiments, the object may be of a vehicle. The image may be grayscale, such that each pixel has a value between 0 and 255. In some embodiments, the image may be depicted in color such as red-green-blue, where each pixel has a red value, a green value, and a blue value. In some embodiments, the object may be cropped such that a portion of the object intersects with the border of the image. Thus, the entire object may not be visible. For example, the image may have been taken too close to the object. Similarly, the image of the object may have been captured, and the image may have been edited (e.g., cropped) such that the object intersects the border of the image. In embodiments, the system may generate an image segmentation mask of the object. The image segmentation mask may be an altered version of the image where the object is highlighted. For example, the image segmentation mask may depict the object in a first color (e.g., white) and the remainder of the image may be a second color (e.g., black). The system may then generate a standardized version of the image segmentation mask (e.g., a standardized image segmentation mask). In embodiment, the system may generate the standardized image segmentation mask by generating a minimum bounding box (e.g., a tight bounding box) of the image segmentation mask. The minimum or tight bounding box may be the smallest polygon with dimensions that include the entirety of the image segmentation mask. The system may then remove (e.g., crop) the region of the image segmentation mask outside the minimum bounding box. Subsequently, the system may resize the cropped image segmentation mask. For example, the system may resize the cropped image segmentation mask based on the following dimensions: (M – 2K, N – 2K), where M is the number of rows in the resulting image, N is the number of columns in the resulting image, and K is a padding factor. Padding factor may refer to a number of pixels that are added to each dimension of the image. In some embodiments, the pixels added based on the padding factor are black pixels. Once the image cropped image segmentation mask is resized to (M – 2K, N – 2K), the system adds zero padding according to the K padding factor. For example, if K is three, then three pixels are added to each side of the image. As an example, if M and N are 300, then the cropped image segmentation mask is resized to 294x294 pixels. Subsequently, the system zero pads the image by adding three pixels to each side (e.g., top, bottom, left, right) such that the resulting standardized image segmentation mask is 300x300 pixels.

The system may then generate a mask edge from the standardized image segmentation mask. The mask edge may depict the outline of the object represented by the image segmentation mask. As a result, the interior color (e.g., white) of the image segmentation mask is changed to the same color as the region of the image that is outside the image segmentation mask (e.g., black). However, the edge of the object represented by the image segmentation mask remains white. To create the mask edge, the system generates an eroded version of the standardized image segmentation mask. The eroded version of the standardized image segmentation mask may be a version of the standardized image segmentation mask with smaller dimensions. In embodiments, the system then removes the eroded version from the standardized version of the image segmentation mask. The system may perform the removal by subtracting the eroded version from the standardized version of the segmentation mask. As a result, pixels in the same positions in the images that are both white, represented by the value 1 or 255, are zeroed out, resulting in black pixels. Thus, only pixels of the same position that are white in the standardized image segmentation mask and black in the eroded version would remain white in the mask edge.

Once the mask edge is generated, the system may determine whether the depicted object is cropped. As previously noted, the standardized image segmentation mask may have M rows and N columns. The system may first sum each of the M rows of pixels in the mask edge, resulting in a vector of M values. The value at each index in the vector is the sum of the pixel values at the row corresponding to the index value. For example, the value at the 1^{st} vector index represents the sum of pixel values along the first row of the mask edge. Similarly, the 2^{nd} vector index represents the sum of pixel values along the second row. In some embodiments, the system may normalize the vector. For example, the system may divide the summation at each index by (N*255). The system then generates a second vector based on the N columns of the mask edge. Similarly, the system may sum each of the N columns of pixels, resulting in a second vector of size N. The value at each index in the vector is the sum of the pixel values at the column corresponding to the index value. For example, the value at the 1^{st} vector index represents the sum of pixel values along the first column of the mask edge. In some embodiments, the system may normalize the second vector by dividing the summation at each index by (M*255).

The system may then compare values within the first and second vectors to a threshold to determine whether the object is cropped. Since the mask edge only depicts white pixels for the edge of the object, a straight line of white pixels may represent an area where the object was cropped. Thus, a high value detected in either vector may correspond to a straight line of white pixels, and therefore be classified as a cropped object.

In some embodiments, the system may inspect a window of values at the beginning of each vector, and from the end of each vector. Noted above, the first vector may correspond to the rows of the image. Thus, the start of the first vector may correspond to rows at the top of the image and the end of the first vector may correspond to rows at the bottom of the image. Similarly, the start of the second vector may correspond to columns at the left side of the image, and the end of the second vector may correspond to columns at the right side of the image. Thus, by inspecting the start and ends of the vector, the system is able to determine where the image would be cropped because the object would intersect with the edge of the image (e.g., top, bottom, left right). This also saves computing resources since the system does not have to compare all values within the vectors. This may be critical for especially large or high resolution images.

Once the system determines the object in the image is cropped, the system may decline to host the image, thereby saving computing and networking resources associated with hosting the image. The system may, in some embodiments, return the image to the party that uploaded it to reformat the image or upload a new, non-cropped version. In some embodiments, the system may apply a label to the image indicating whether an object in the image is cropped. For example, the system may determine an image depicts a cropped object, label the image as including cropped object, and transmit the labeled image to the party that uploaded it. In some embodiments, the system may annotate the image to highlight a region of the image where the object is cropped.

Various embodiments of these features will now be discussed with respect to the corresponding figures.

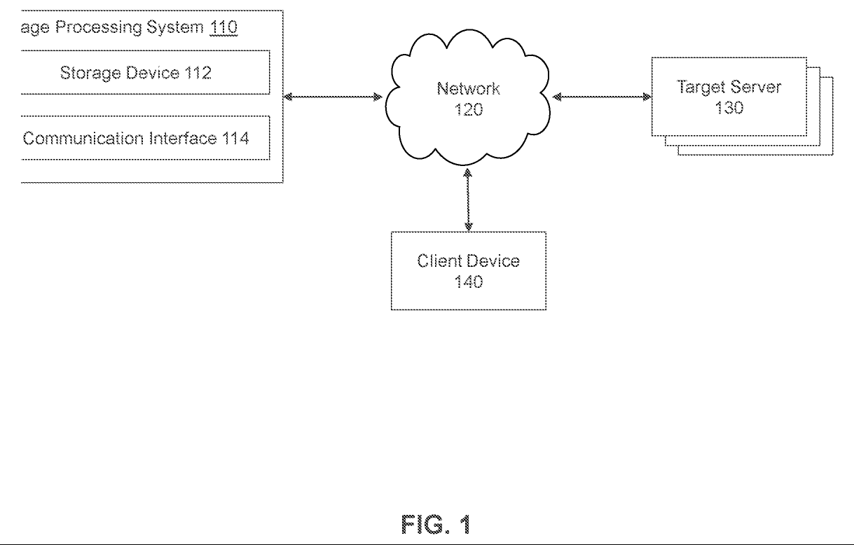

FIG. 1 depicts a block diagram of environment 100. Environment 100 includes image processing system 110, network 120, target server 130, and client device 140.

Image processing system 110 may be any device configured to receive an image and detect whether an object in the image is cropped. For example, image processing system 110 may receive an image of a vehicle for posting to an e-commerce website. Similarly, image processing system 110 may receive an image for posting to a social media site. In some embodiments, where image processing system 110 determines the image includes a cropped object, image processing system 110 may not host the image, thus saving computing and networking resources. In some embodiments, image processing system 110 may return the cropped image to the source for reformatting or recapture. In some embodiments, image processing system 110 may label each image indicating whether it includes a cropped object.

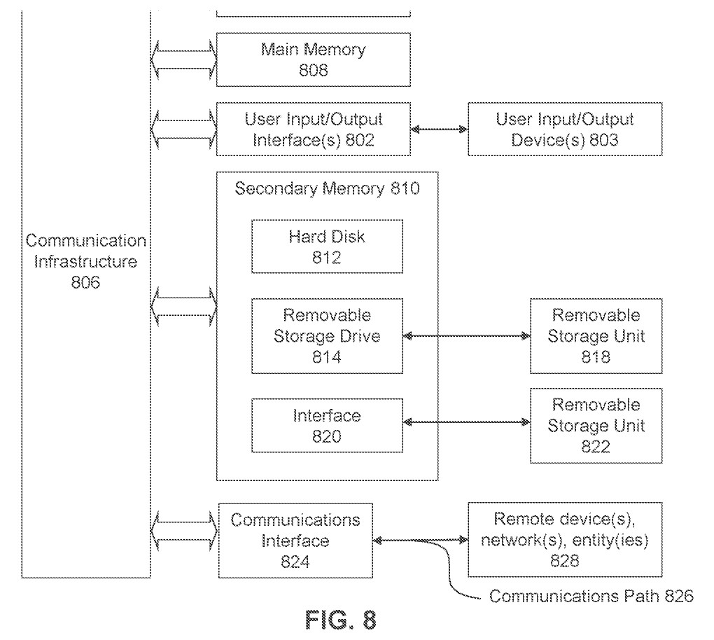

Image processing system 110 may be implemented using a computing device such as a desktop workstation, laptop or notebook computer, netbook, tablet, smart phone, and/or other computing device. In some embodiments, image processing system 110 may be implemented as an application in an enterprise computing system and/or a cloud-computing system. In some embodiments, image processing system 110 may be a computer system such as computer system 800 described with reference to FIG. 8. In some embodiments, image processing system 110 may host the processed image for display. For example, image processing system 110 may utilize one or more servers to host an e-commerce website displaying uploaded images.

Image processing system 110 includes storage device 112 and communication device 114. Storage device 112 may be any memory storage device. Image processing system 110 may use storage device 112 to store data such as received images. Communication device 114 may comprise any suitable network interface capable of transmitting and receiving data, such as, for example a modem, an Ethernet card, a communications port, or the like. Communications device 114 may be able to transmit data using any wireless transmission standard such as, for example, Wi-Fi, Bluetooth, cellular, or any other suitable wireless transmission. Image processing system 110 may use communication device 114 to communicate with entities on network 120. For example, image processing system 110 may use communication device 114 to receive images from client device 140. Similarly, image processing system 110 may transmit images to target server 130 via network 120.

As noted above, image processing system 110 may receive an image. In some embodiments, image processing system 110 may perform a crop detection process to determine whether an object in the image is cropped. For example, image processing system 110 may be configured to detect a region of the image depicting the cropped object, and generate a polygon (e.g., bounding box) defining the region of the cropped object. In some embodiments, image processing system 110 may provide a confidence score indicating the likelihood that the image includes a cropped object. The confidence score may be represented as a probability (e.g., 50%). In some embodiments, image processing system 110 may decline to host an image if the confidence score that the image depicts a cropped object is greater than a predefined threshold such as 80%.

Network 120 may be any type of computer or telecommunications network capable of communicating data, for example, a local area network, a wide-area network (e.g., the Internet), or any combination thereof. The network may include wired and/or wireless segments.

Target server 130 may be a computing device configured to store images. In some embodiments, target server 130 may provide one or more images to image processing system 110 for cropped object detection. In some embodiments, target server 130 may receive images from image processing system 110 indicating whether they include cropped objects. Target server 130 may be implemented using a computing device such as a desktop workstation, laptop or notebook computer, netbook, tablet, smart phone, and/or other computing device. In some embodiments, target server 130 may be implemented as an application in an enterprise computing system and/or a cloud-computing system. In some embodiments, target server 130 may be a computer system such as computer system 800 described with reference to FIG. 8. Although target server 130 and image processing system 110 are depicted as separate entities, in some embodiments, target server 130 may include image processing system 110, or vice versa. For example, target server 130 may host a social media website and include image processing system 110 to detect whether images uploaded by users of the social media website include cropped objects.

Client device 140 may be any device configured to interact with image processing system 110 and target server 130. For example, client device 140 may store one or more images to be uploaded to target server 130. Client device 140 may send the one or more images to target server 130, and target server 130 may forward the one or more images to image processing system 110 for cropped object detection. In some embodiments, client device 140 may send the one or more images to image processing system 110. Image processing system 110 may detect whether the one or more images include cropped objects and return the labeled one or more images to client device 140. In some embodiments, image processing system 110 may directly send the labeled images to target server 130.

Client device 140 may be implemented using a computing device such as a desktop workstation, laptop or notebook computer, netbook, tablet, smart phone, and/or other computing device. In some embodiments, client device 140 may be implemented as an application in an enterprise computing system and/or a cloud-computing system. In some embodiments, client device 140 may be a computer system such as computer system 800 described with reference to FIG. 8.

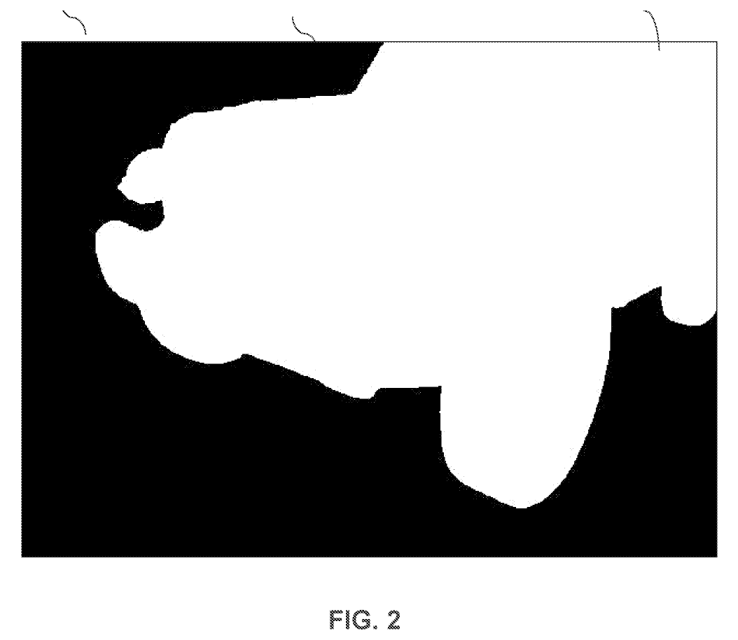

FIG. 2 depicts an image segmentation mask 200 of a cropped image, according to some embodiments. Image segmentation mask 200 may depict an object within an image. For example, the object of image segmentation mask 200 may be depicted in a first pixel color (e.g., white, 255). A remaining area (e.g., the background) of image segmentation mask 200 may be depicted in a second pixel color (e.g., black, 0). For example, the image may depict a vehicle. As a result, image segmentation mask 200 may show an outline of the vehicle depicted in the image drawn using white pixels. Image segmentation mask 200 may include object region 210 and background region 220. Object region 210 may depict the object in the image (e.g., the vehicle). Background region 220 may include the remainder of the image. In some embodiments, image processing system 110 may generate image segmentation mask 200 from an image. In some embodiments, image processing system 110 may receive image segmentation mask 200 from, for example, target server 130 or client device 140.

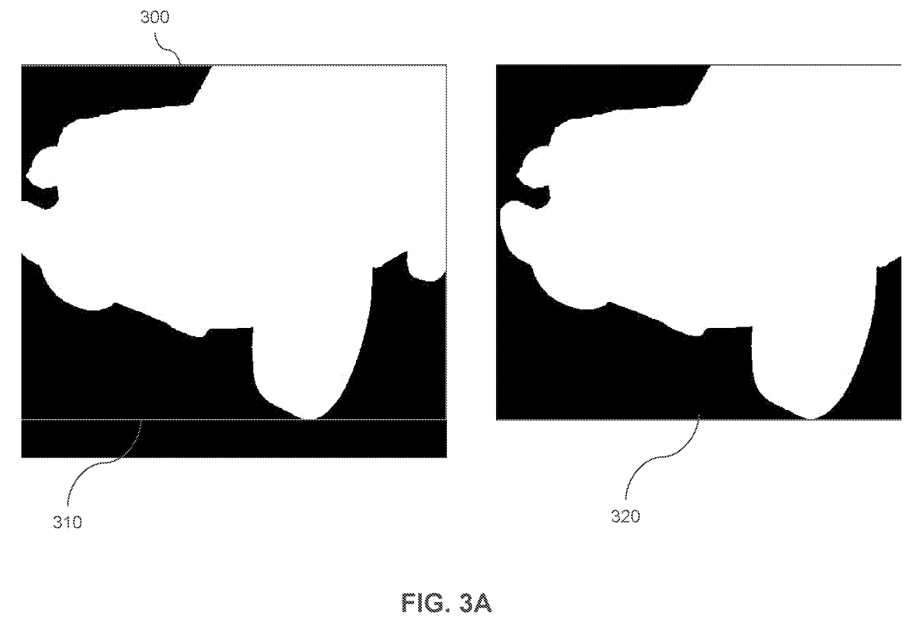

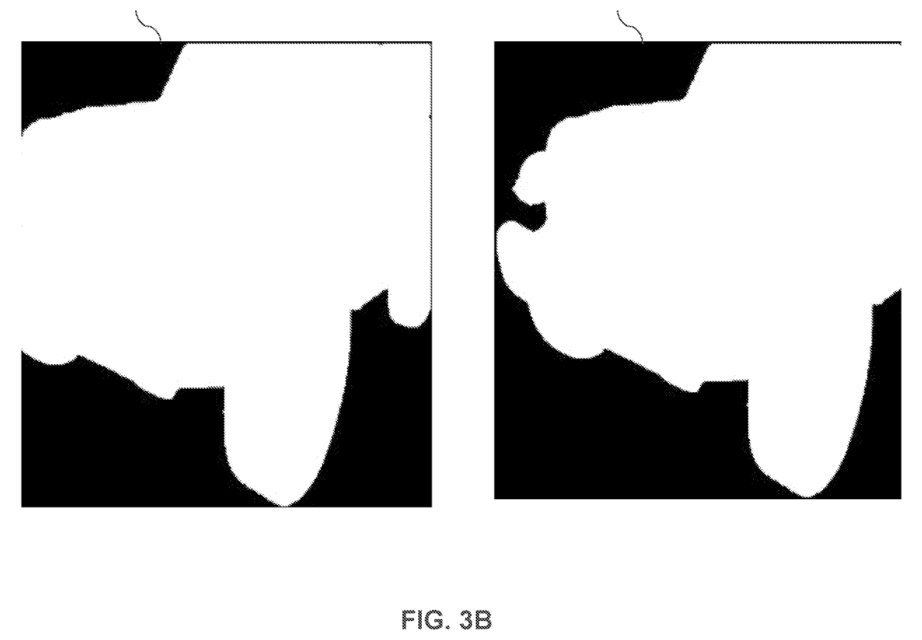

FIGS. 3A & 3B depict generating a standardized image segmentation mask, according to some embodiments. FIG. 3A includes image segmentation mask 300, minimum bounding box 310, and cropped image segmentation mask 320. Image segmentation mask 300 may be image segmentation mask 200 described with respect to FIG. 2. Minimum bounding box 310 may be the smallest possible polygon configured to contain the object region of image segmentation mask 300. Image processing system 110 may be configured to generate minimum bounding box 310. As depicted, image segmentation mask 300 may depict a vehicle. As a result, minimum bounding box 310 may be a polygon with dimensions containing each part of the vehicle depicted by image segmentation mask 300. Image processing system 110 may use image segmentation mask 300 and minimum bounding box 310 to generate cropped image segmentation mask 320. Cropped image segmentation mask 320 may be image segmentation mask 300 with all pixels outside minimum bounding box 310 removed.

FIG. 3B includes resized image segmentation mask 330 and standardized image segmentation mask 340. Image processing system 110 may generate resized image segmentation mask 330 from cropped image segmentation mask 320. Image processing system 110 may generate resized image segmentation mask 330 by resizing cropped image segmentation mask 320. In some embodiments, image processing system 110 may reference a formula such as: (M – 2K, N – 2K), where M is the number of rows in the resulting image, N is the number of columns in the resulting image, and K is a padding factor. M, N, and K may be predefined values For example, M and N may each equal 300, and K may equal 3. Image processing system 110 may generate resized image segmentation mask 330 having dimensions of 294x294 pixels. Image processing system 110 may then generate standardized image segmentation mask 340 based on resized image segmentation mask 330 and the padding factor K. K may represent the number of pixels with which to pad resized image segmentation mask 330. Padding may refer to adding black pixels to each side (e.g., top, bottom, left, right) of the image. As a result, if K equals 3, dimensions of standardized image segmentation mask 340 may be 300x300 after adding 3 black pixels to each side.

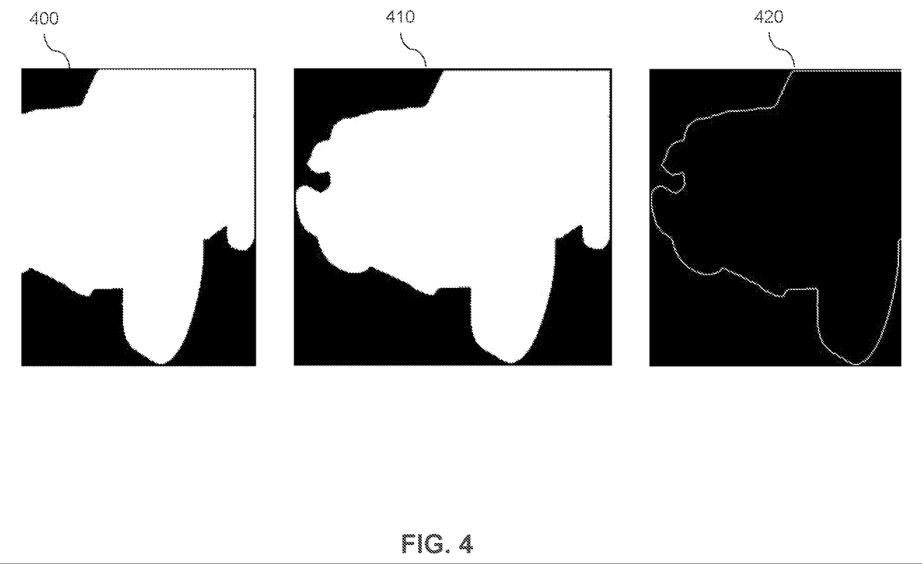

FIG. 4 depicts standardized image segmentation mask 400, eroded mask 410, and mask edge 420. Standardized image segmentation mask 400 may be standardized image segmentation mask 340 discussed with reference to FIG. 3B. Image processing system 110 may generate eroded mask 410 by shrinking the area of the object depicted in standardized image segmentation mask 400. Image processing system 110 may use a kernel filter to generate eroded mask 410. A kernel filter may be an NxN matrix. For example, the kernel may be 3 pixels x 3 pixels. Image processing system 110 may slide the kernel filter over standardized image segmentation mask 400. In some embodiments, the size of the kernel filter may be a function of the resolution of the image corresponding to standardized image segmentation mask 400. For example, the higher the resolution of the image, the larger the kernel filter may be. Similarly, the size of the kernel filter may be a function of the size of the image. The larger the image, the larger the kernel filter that may be used to generate eroded mask 410.

Image processing system 110 may be configured to slide the kernel filter over standardized image segmentation mask 400 and apply an update rule. In some embodiments, the update rule may dictate that if the kernel filter includes pixel values representing both the standardized image segmentation mask 400 region (e.g., white pixels) and pixels outside standardized image segmentation mask 400 (e.g., black pixels), then all pixel values covered by the kernel filter are updated to match the outer region (e.g., black pixels). As a result, standardized image segmentation mask 400 may be reduced into eroded mask 410, because areas along the edge of standardized image segmentation mask 400 would be updated from white pixels to black pixels. In some embodiments, image processing system 110 may use different sized kernel filters. For example, when a smaller kernel filter is used, eroded mask 410 may be smaller than when a larger kernel filter is used.

Image processing system 110 may then generate mask edge 420 by subtracting eroded mask 410 from standardized image segmentation mask 400. For example, image processing system 110 may perform the subtraction such that the value of each pixel in eroded mask 410 is subtracted from the value of the pixel in the same position in standardized image segmentation mask 400. In some embodiments, only pixels that are white in standardized image segmentation mask 400 with corresponding black pixels in eroded mask 410 may remain white in the generated mask edge 420. Image processing system 110 may represent black pixels with the value 0. As result, pixels in both standardized image segmentation mask 400 and eroded mask 410 that are white are zeroed out and represented as black pixels.

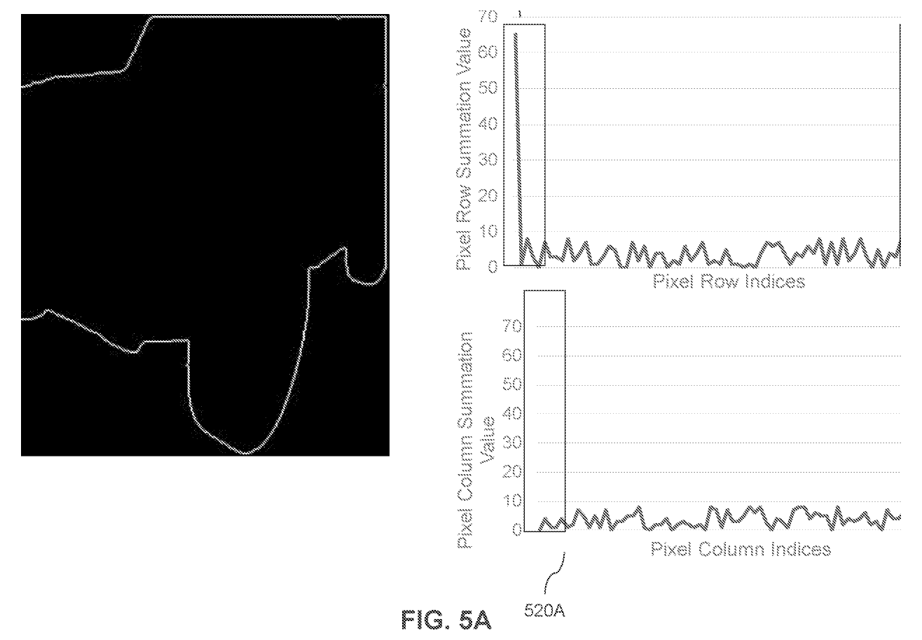

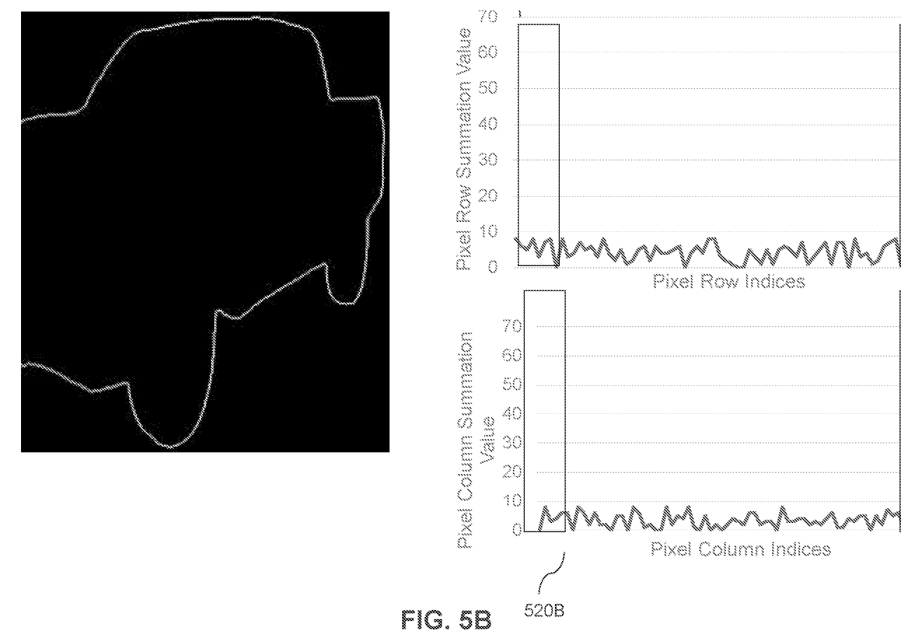

FIGS. 5A – 5B depict plotting pixel value summations, according to some embodiments. FIG. 5A includes mask edge 500A, pixel row summation plot 510A, pixel column summation plot 520A, and window 530. Mask edge 500A may be mask edge 420 as discussed with reference to FIG. 4.

Image processing system 110 may use mask edge 500A to determine whether the original image includes a cropped object. Image processing system 110 may be configured to determine whether there is a cropped object by summing pixel values along each row in the image (e.g., mask edge 500A) and summing pixel values along each column. Pixel row summation plot 510A is a graphical representation of summing pixel values along each row, and pixel column summation plot 520A is a graphical representation of summing pixel values along each column.

To generate pixel row summation plot 510A and pixel column summation plot 520A, image processing system 110 may generate two vectors. The first vector may be configured to store pixel row summations and the second vector may be configured to store pixel column summations. The first vector may have dimensions of 1xM, where M is the number of rows in the image. The second vector may have dimensions of 1xN, where N is the number of columns in the image. Image processing system 110 may then sum the pixel values along each row in mask edge 500A, and store the summation of each row in the first vector. As a result, the value at each index in the first vector corresponds to the summation of pixel values at the row corresponding to the index. For example, the summation at the 2^{nd} index is the summation of pixel values along the 2^{nd} row of mask edge 500A. Image processing system 110 may further sum the pixel values along each column in mask edge 500A, and store the summation of each column in the second vector. Similarly, each index of the second vector corresponds to a column from mask edge 500A. For example, the summation at the 2^{nd} index is the summation of pixel values along the 2^{nd} column of mask edge 500A.

Image processing system 110 may be configured to determine whether the image depicts a cropped object by comparing values within the first and second vectors to a predefined threshold value. As discussed above, mask edge 500A shows the edges of the object depicted in the original image. Thus, if the object is cropped such that part of it is cut off (i.e., not visible), then the part of the object that is cropped would be a straight line intersecting the border of the image. For example, if mask edge 500A depicts an object that is cropped at the top of the image, then mask edge 500A would depict a line of pixels running along the top edge of the image where the object is cropped. Since the first vector stores summations along the pixel rows, the summation corresponding to the line of pixels running along the top edge of the image would have a high value. Similarly, if mask edge 500A depicts an object that is cropped at the right side of the image, then mask edge 500A would depict a line of pixels running along the right edge of the image where the object is cropped. Here, the second vector would include a summation with a high value that corresponds to the column of pixels running along the right edge of the image. As a result, image processing system 110 may be configured to compare each value within the first and second vectors to a predefined threshold to determine whether the image is cropped. For example, if image processing system 110 detects a vector value greater than 100, it may determine the image depicts a cropped object at a location corresponding to the value’s index. In some embodiments, each vector may have a different threshold. For example, the first vector corresponding to pixel rows may have a first threshold, and the second vector corresponding to pixel columns may have a second threshold.

For example, as depicted in FIG. 5A, mask edge 500A depicts a vehicle cropped at the top and right sides. As a result, pixel row summation plot 510A has a spike in pixel values on the left side, corresponding to the top of the image. Similarly, column row summation plot 520A has a spike in pixel values on the right side, corresponding to the right side of the image.

In some embodiments, image processing system 110 may normalize each vector prior to performing the comparison. Image processing system 110 may normalize each vector by the magnitude (e.g., length) of each vector. In some embodiments, image processing system 110 may normalize the first vector (e.g., the row summation vector) by dividing each value by (N*255), where M is the number of rows in the image. In some embodiments, image processing system 110 may normalize the second vector (e.g., the column summation vector) by dividing each value by (M*255), where N is the number of columns in the image.

In some embodiments, image processing system 110 may compare a subset of values within the first and second vectors to the threshold. As noted above, if the image depicts a cropped object then the object would be cropped at an edge (e.g., top, bottom, left, or right) of the image. Thus to save computing resources, image processing system 110 may only inspect summation values corresponding to the top, bottom, left, and right sides of the image. Since the indices in the first vector correspond to the rows, image processing system 110 may inspect a predefined number of indices at the beginning of the first vector, corresponding to the top of the image. Image processing system 110 may inspect a predefined number of indices from the end of the first vector corresponding to the bottom of the image. Image processing system 110 may perform a similar process for the second vector corresponding to the column summations. Similarly, image processing system 110 may begin inspecting summation values at indices beginning after zero-padding. Since K pixels were added to each side of the image, image processing system 110 may begin inspecting vector values at the index after the indices corresponding to the zero-padding. For example, if the padding factor K were two, then the first two values of the vectors would be [0, 0] corresponding to the two additional pixels added according to K. Thus, to save resources image processing system 110 may begin at the index after the indices corresponding to the zero-padded pixels (e.g., the third index).

In some embodiments, image processing system 110 may compare values in multiple indices of a vector to the predefined threshold. Based on the image quality, an object edge may not be depicted in a single row of pixels. As a result, image processing system 110 may use window 530 to consider multiple indices of a vector at once. In some embodiments, the size of window 530 indicating the number of indices it covers (e.g., the width) may be a function of the kernel filter used to generate the eroded mask (e.g., eroded mask 410). In some embodiments, image processing system 110 may reference a data set to identify a window size. The data set may include images that are labeled with whether they include depictions of cropped objects. Image processing system 110 may determine whether images in the data set depict cropped objects by using varying window sizes and calculating precision and recall values for each window size. For example, increasing the width may improve recall but decrease precision because the number of false positives occur. In some embodiments, image processing system 110 may utilize a window size that maximizes recall for a desired precision. For example, if the desired precision is 90%, image processing system 110 may select the window size corresponding to the maximum recall achievable given 90% precision.

As noted above, image processing system 110 may begin inspecting vector values at the index after the zero-padding. Thus, if the zero-padding factor were two, image processing system 110 may begin at index three. As a result, window 530 may also be initialized at the third index three to start with the values after the zero-padded pixels. Furthermore, window 530 may have a size greater than one, such that it considers multiple indices of the vector at once. For example, if window 530 has a size equal to three, image processing system 110 may consider three vector values at a time to determine whether the object is cropped. In some embodiments, image processing system 110 may compute the sum of the indices included in window 530, and compare the sum to the predefined threshold. For example, image processing system 110 may be configured to use predefined threshold of 100 to determine whether the image depicts a cropped object and window 530 may be size three. Image processing system 110 may sum pixel values of the first five rows of pixels resulting in first vector values of [60, 30, 15, 6, 8]. Since window 530 is size three, image processing system 110 may slide window 530, summing the vector values within the window, and compare the sum to the threshold to determine whether the image depicts a cropped object. Here, image processing system 110 would sum [60, 30, 15], [30, 15, 6], and [15, 6, 8], resulting in sums of 105, 51, and 29, respectively. Since 105 is greater than the predefined threshold of 100, image processing system 110 would determine that the image depicts a cropped object. Using window 530 allows image processing system 110 to correct for lower quality images where the edge may span across collocated rows and/or columns. For instance, in the preceding example, if image processing system 110 used window 530 of size one, it would not detect the image depicts cropped object because none of the individual values [60, 30, 15, 6, 8] are greater than the threshold. Thus, window 530 allows image processing system 110 to detect cropped objects that would otherwise be missed.

In some embodiments, image processing system 110 may generate a confidence score corresponding to the likelihood that the image depicts a cropped object. For example, the confidence score may be a function of the difference between the maximum value in the first or second vector, and the predefined threshold for determining the object is cropped. Thus, the greater the difference between the maximum value and the threshold, the more likely the image depicts a cropped object.

In some embodiments, image processing system 110 may label whether an object in the image is cropped. For example, image processing system 110 may have received the image and the image segmentation mask from an entity on network 120 such as client device 140 or target sever 130. Image processing system 110 may return the image with a label indicating that it depicts a cropped object. In some embodiments, image processing system 110 may return the generated mask edge as well.

FIG. 5B illustrates mask edge 500B that does not depict a cropped object. As a result, pixel row summation plot 510B and pixel column summation plot 520B show relatively flat values based on the absence of a line of pixels intersecting an edge of the image where it would be cropped.

As noted above, image processing system 110 may use a predefined threshold to determine whether the image includes a cropped object. Image processing system 110 may use a fixed value. In some embodiments, image processing system 110 may automatically determine the threshold. For example, image processing system 110 may reference a labeled data set of images depicting cropped and non-cropped objects. Image processing system 110 may use the threshold value that provides the maximum recall for a desired precision. For example, if the desired precision is 90%, image processing system 110 may select the threshold corresponding to the maximum recall achievable given 90% precision.

In some embodiments, image processing system 110 may be configured to generate a threshold based on the type and orientation of object depicted in the image. For example, image processing system 110 may be configured to determine whether vehicles in images are cropped. In some embodiments, image processing system 110 may automatically determine thresholds for each style of vehicle (e.g., sedan, pickup truck, SUV). In some embodiments, image processing system 110 may automatically determine thresholds for each side of the image. For example, image processing system 110 may use a different threshold for determining whether an object at the top of the image is cropped as compared to the left side of the image. Furthermore, image processing system 110 may determine thresholds based on the orientation of the object in the image. For example, if the objects are vehicles, image processing system 110 may have different thresholds for how the vehicle is depicted. For example, image processing system 110 may have different thresholds for when the vehicle is depicted head on, the side of the vehicle is depicted, the rear of the vehicle is depicted, the front driver side of the vehicle is depicted, the front passenger side of the vehicle is depicted, the rear driver side of the vehicle is depicted, the rear passenger side of the vehicle is depicted, among others. In some embodiments, image processing system 110 may perform object detection in order to determine the object depicted in the image, and an orientation of the object. As a result, image processing system 110 may utilize thresholds corresponding to the object and the orientation of the object.

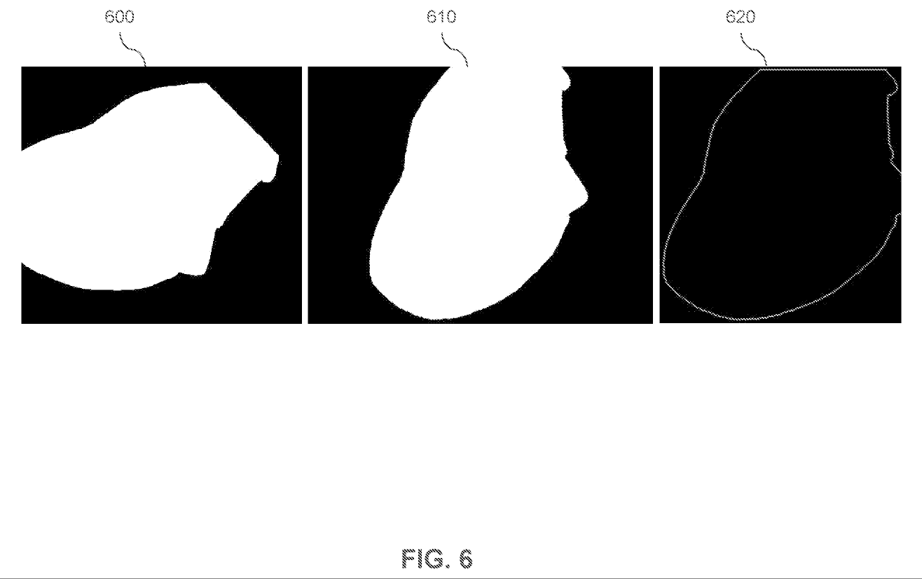

FIG. 6 depicts rotating an image to determine whether it depicts a cropped object, according to some embodiments. In some embodiments, the image received by image processing system 110 may be askew. For example, image processing system 110 may generate standardized image segmentation mask 600 representing a vehicle that has a portion cropped, but the cropped portion does not intersect the edge of the image. Here, image processing system 110 may iteratively rotate the image by a predefined degree(s), and after each rotation, perform the process described above to determine whether the image is cropped. For example, image processing system 110 may rotate standardized image segmentation mask 600 by 45° resulting in rotated standardized image segmentation mask 610. As depicted, the cropped region of mask edge 620 of rotated standardized image segmentation mask 610 intersects with the top of the image. As a result, image processing system 110 may determine the object is cropped. In some embodiments, image processing system 110 may be configured to iteratively rotate all image segmentation masks a predefined number of times. Image processing system 110 may be configured to stop rotating the image segmentation masks once it detects the object of the image segmentation mask is cropped. In some embodiments, image processing system 110 may continue to rotate image segmentation mask after detecting the object is cropped.

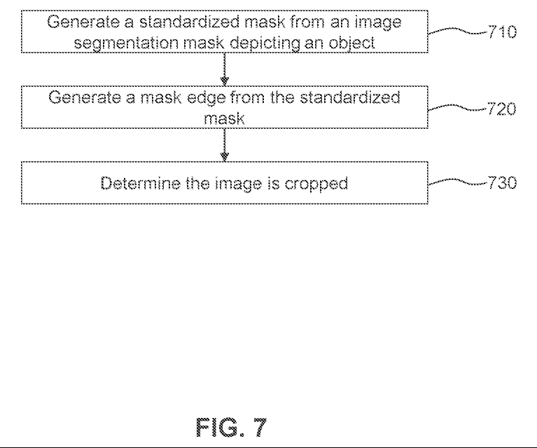

FIG. 7 depicts a flowchart illustrating a method for determining whether an image depicts a cropped object, according to some embodiments. Method 700 shall be described with reference to FIG. 1, however, method 700 is not limited to that example embodiment.

In an embodiment, imaging processing system 110 may utilize method 700 to determine whether an image depicts an object that is cropped. The foregoing description will describe an embodiment of the execution of method 700 with respect to imaging processing system 110. While method 700 is described with reference to imaging processing system 110, method 700 may be executed on any computing device, such as, for example, the computer system described with reference to FIG. 11 and/or processing logic that may comprise hardware (e.g., circuitry, dedicated logic, programmable logic, microcode, etc.), software (e.g., instructions executing on a processing device), or a combination thereof. For example, method 700 may be executed on target server 130 or client device 140.

It is to be appreciated that not all steps may be needed to perform the disclosure provided herein. Further, some of the steps may be performed simultaneously, or in a different order than shown in FIG. 7.

At 710, image processing system 110 generates a standardized mask from an image segmentation mask. The image segmentation mask may be image segmentation mask 300. Image processing system 110 may receive the image segmentation mask along with the original image from an entity on network 120. In some embodiments, image processing system 110 may receive the image and generate the image segmentation mask. Image processing system 110 may first generate a minimum bounding box surrounding the object in the image segmentation mask. Image processing system 110 may then remove (e.g., crop) the region outside the minimum bounding box. Image processing system 110 may then resize the image. Image processing system 110 may use a formula such as (M – 2K, N – 2K), where M is the number of rows in the resulting image, N is the number of columns in the resulting image, and K is a padding factor. Image processing system 110 may resize the image to size (M – 2K, N – 2K). Image processing system 110 may then zero-pad the image with K pixels on each side to generate the standardized image segmentation mask. The standardized image segmentation mask may be standardized image segmentation mask 340.

At 720, image processing system 110 generates a mask edge from the standardized image segmentation mask. The mask edge may be mask edge 420. The mask edge may depict the outline of the object represented by the image segmentation mask. As a result, the interior color (e.g., white) of the image segmentation mask is changed to the same color as the region of the image that is outside the image segmentation mask (e.g., black). However, the edge of the object represented by the image segmentation mask remains white. Image processing system 110 may generate the mask edge by generating an eroded version of the standardized image segmentation mask, and subtracting pixel values in the eroded version from the standardized image segmentation mask.

At 730, image processing system 110 determines the image includes an object that is cropped. Image processing system 110 may determine the image includes a cropped object by generating two vectors. The first vector may be generated by summing each row of pixel values in the mask edge. The second vector may be generated by summing each column of pixel values in the mask edge. Image processing system 110 may then compare values within the first and second vectors to a predefined threshold to determine whether the object is cropped. In some embodiments, image processing system 110 may consider multiple vector indices that are within a certain window size. For example, if the window size is three, image processing system 110 may consider three vector values at a time. This is beneficial to account for image quality issues where lines may cross pixel rows or columns within the image. In some embodiments, image processing system 110 may only consider certain values within the vectors. Noted above, the ends of the first vector may correspond to the top and bottom of the image, and the ends of the second vector may correspond to the right and left sides of the image. Thus, image processing system 110 may only consider a predefined number of values from the end of each vector.

In some embodiments, the predefined threshold used to determine whether the object is cropped may be based on the type of object and/or the orientation of the object. For example, if the object is a vehicle, image processing system 110 may select a threshold based on the type of vehicle (e.g., sedan, SUV, pickup truck). Similarly, image processing system 110 may select a predefined threshold based on how the object is oriented. For example, image processing system 110 may have a first threshold if the vehicle is oriented head on, and a second threshold if the vehicle is oriented sideways.

Image processing system 110 may take various actions based on determining an object in the image is cropped. For example, image processing system 110 may have received the image for posting on a platform such as a social media website. Here, image processing system 110 may return the image to the entity that submitted the image along with an indication that the object in the image is cropped. This is beneficial so the entity may re-capture the image without the image being cropped. In some embodiments, image processing system 110 may send the image along with an indication that the object in the image is cropped to the platform, and the platform may determine whether to host the image.

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (e.g., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/ any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method comprising:
generating a standardized mask from an image segmentation mask depicting an object within an image by:
identifying a minimum bounding box configured to surround the image segmentation mask within the image;
removing a portion of the image outside the bounding box from the image; and
resizing the image based on a predefined number of rows of pixels in the image and a predefined number of columns of pixels in the image;
modifying the image by adding a predefined number of pixels between an edge of the image and the standardized mask;
generating a mask edge by:
generating an eroded version of the standardized mask using an erosion kernel; and
removing the eroded version of the standardized mask from the standardized mask;
determining the image is cropped by:
generating a first vector by, for each row within the number of rows of pixels in the image:
generating a summation of pixel values along the row; and
storing the summation within the first vector at an index corresponding to a position of the row within the number of rows;
generating a second vector by, for each column within the number of columns of pixels in the image:
generating a summation of pixel values along the column; and
storing the summation within the second vector at an index corresponding to a position of the column within the number of columns; and
identifying a summation within the first vector or second vector that is greater than a predefined threshold.

2. The method of claim 1, wherein the summation within the first vector is a first summation within a first summation subset and wherein the summation within the second vector is a second summation within a second summation subset.

3. The method of claim 1, wherein generating the first vector further comprises, for each summation of the first vector, dividing the summation by the number of columns, and wherein generating the second vector further comprises, for each summation of the second vector, dividing the summation by number of rows.

4. The method of claim 1, further comprising repeatedly determining whether the image is cropped for a predefined number of iterations, wherein after each iteration the image is rotated by predefined number of degrees.

5. The method of claim 1, wherein the object is a car.

6. The method of claim 5, wherein the predefined threshold is based on at least one of: (1) a body style of the car; or (2) an orientation of the car depicted in the image.

7. The method of claim 1, wherein the predefined threshold is selected from a range of thresholds based on the predefined threshold having a maximal recall value for a selected precision value.

8. A system, comprising:
a memory; and
at least one processor coupled to the memory and configured to:
generate a standardized mask from an image segmentation mask depicting an object within an image by:
identifying a minimum bounding box configured to surround the image segmentation mask within the image;
removing a portion of the image outside the bounding box from the image; and
resizing the image based on a predefined number of rows of pixels in the image and a predefined number of columns of pixels in the image;
modify the image by adding a predefined number of pixels between an edge of the image and the standardized mask;
generate a mask edge by:
generating an eroded version of the standardized mask using an erosion kernel; and
removing the eroded version of the standardized mask from the standardized mask;
determine the image is cropped by:
generating a first vector by, for each row within the number of rows of pixels in the image:
generating a summation of pixel values along the row; and
storing the summation within the first vector at an index corresponding to a position of the row within the number of rows;
generating a second vector by, for each column within the number of columns of pixels in the image:
generating a summation of pixel values along the column; and
storing the summation within the second vector at an index corresponding to a position of the column within the number of columns; and
identifying a summation within the first vector or second vector that is greater than a predefined threshold.

9. The system of claim 8, wherein the summation within the first vector is a first summation within a first summation subset and wherein the summation within the second vector is a second summation within a second summation subset.

10. The system of claim 8, wherein to generate the first vector, the at least one processor is further configured to: for each summation of the first vector, dividing the summation by the number of columns, and wherein generating the second vector further comprises, for each summation of the second vector, dividing the summation by the number of rows.

11. The system of claim 8, wherein the at least one processor is further configured to repeatedly determine whether the image is cropped for a predefined number of iterations, wherein after each iteration the image is rotated by predefined number of degrees.

12. The system of claim 8, wherein the object is a car.

13. The system of claim 12, wherein the predefined threshold is based on at least one of: (1) a body style of the car; or (2) an orientation of the car depicted in the image.

14. The system of claim 8, wherein the predefined threshold is selected from a range of thresholds based on the predefined threshold having a maximal recall value for a selected precision value.

15. A non-transitory computer-readable device having instructions stored thereon that, when executed by at least one computing device, cause the at least one computing device to perform operations comprising:
generating a standardized mask from an image segmentation mask depicting an object within an image by:
identifying a minimum bounding box configured to surround the image segmentation mask within the image;
removing a portion of the image outside the bounding box from the image; and
resizing the image based on a predefined number of rows of pixels in the image and a predefined number of columns of pixels in the image;
modifying the image by adding a predefined number of pixels between an edge of the image and the standardized mask;
generating a mask edge by:
generating an eroded version of the standardized mask using an erosion kernel; and
removing the eroded version of the standardized mask from the standardized mask;
determining the image is cropped by:
generating a first vector by, for each row within the number of rows of pixels in the image:
generating a summation of pixel values along the row; and
storing the summation within the first vector at an index corresponding to a position of the row within the number of rows;
generating a second vector by, for each column within the number of columns of pixels in the image:
generating a summation of pixel values along the column; and
storing the summation within the second vector at an index corresponding to a position of the column within the number of columns; and
identifying a summation within the first vector or second vector that is greater than a predefined threshold.

16. The non-transitory computer-readable device of claim 15, wherein the summation within the first vector is a first summation within a first summation subset and wherein the summation within the second vector is a second summation within a second summation subset.

17. The non-transitory computer-readable device of claim 15, wherein generating the first vector further comprises, for each summation of the first vector, dividing the summation by N, and wherein generating the second vector further comprises, for each summation of the second vector, dividing the summation by M.

18. The non-transitory computer-readable device of claim 15, the operations further comprising repeatedly determining whether the image is cropped for a predefined number of iterations, wherein after each iteration the image is rotated by predefined number of degrees.

19. The non-transitory computer-readable device of claim 15, wherein the object is a car and wherein the predefined threshold is based on at least one of: (1) a body style of the car; or (2) an orientation of the car depicted in the image.

20. The non-transitory computer-readable device of claim 15, wherein the predefined threshold is selected from a range of thresholds based on the predefined threshold having a maximal recall value for a selected precision value.
